(19) United States
(12) Patent Application Publication
(10) Pub. No.: US 2017/0289002 A1
(43) Pub. Date: Oct. 5, 2017

(54) TECHNOLOGIES FOR DEPLOYING DYNAMIC UNDERLAY NETWORKS IN CLOUD COMPUTING INFRASTRUCTURES

(71) Applicants: Mrittika Ganguli, Bangalore (IN); Deepak S, Bangalore (IN); Ananth S. Narayan, Bangalore (IN); Hubert Sokolowski, Drogi (IE)

(72) Inventors: Mrittika Ganguli, Bangalore (IN); Deepak S, Bangalore (IN); Ananth S. Narayan, Bangalore (IN); Hubert Sokolowski, Drogi (IE)

(21) Appl. No.: 15/087,172

(22) Filed: Mar. 31, 2016

(51) Int. Cl. H04L 12/26; H04L 12/46; H04L 29/08

(52) U.S. Cl. CPC H04L 43/0876; H04L 67/10; H04L 12/4641

(57) ABSTRACT

Technologies for deploying dynamic underlay networks in a cloud computing infrastructure include a network controller of the cloud computing infrastructure communicatively coupled via disaggregated switches to one or more compute nodes of the cloud computing infrastructure. The network controller is configured to receive tenant network creation requests from a cloud operating system (OS) of the cloud computing infrastructure indicating that a tenant network is to be created in the cloud computing infrastructure (e.g., for a new tenant of the cloud computing infrastructure). The network controller is configured to provision an underlay network to support the tenant network based on identified physical resources using criteria specified by the cloud OS and transmit information of the provisioned underlay network to the cloud OS that is usable to create a cloud visible overlay network associated with the underlay network. Other embodiments are described herein.

### BACKGROUND

Traditional data centers are based around the server as the fundamental computing unit. In such traditional data centers, each server typically includes its own dedicated computing resources (e.g., processors, memory, storage, and networking hardware/software) and individual servers may be stacked together with high density into racks, and multiple racks may be arranged in a data center. Some modern datacenter technologies have been introduced which disaggregate computing resources. In particular, rack-scale architecture has recast the computing rack as the fundamental unit of computing for large data centers. In such rack-scale architectures, each computing rack typically includes multiple pooled systems (e.g., collections of pooled compute nodes, pooled memory, and pooled storage over a rack-scale fabric). By disaggregating and pooling computing resources, rack-scale architecture allows improved flexibility and scalability of data centers. For example, individual computing resources (e.g., compute nodes and/or memory) can be dynamically added/removed and/or partitioned among workloads. Additionally, rack-scale architecture may improve data center thermal management and power consumption by sharing such resources, which may in turn improve compute density, performance, and efficiency.

In cloud computing infrastructures, management of the computing resource pools is a key to handling dynamically changing business strategy and network requirements. In some cloud computing infrastructures, network virtualization technologies are implanted to enable independent networks per tenant using overlay networks (e.g., creating individual virtual local area networks (VLANs) for each tenant to keep virtual network traffic isolated). However, while overlay networks have their advantages, overhead is introduced from data traversing intermediate nodes (e.g., data-path overhead, processing delays, etc.) which can result in degradation in application performance. Additionally, overlay networks fight for shared resources (e.g., shared memory, disk storage, cache memory, etc.), which can result in resource contention by competing overlay networks. Accordingly, underlay networks have been introduced due to their potential to overcome some of the issues attributable to the overlay networks; however, underlay networks are statically configured and created during cloud setup/configuration. As a result, such underlay networks are also susceptible to being oversubscribed or undersubscribed, resulting in sub-optimal resource utilization.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for deploying dynamic underlay networks in a cloud computing infrastructure using a rack-scale computing architecture;

FIG. 2 is a simplified block diagram of at least one embodiment of an underlay network in the system of FIG. 1;

FIG. 3 is a simplified block diagram of at least one embodiment of an environment that may be established by a network controller of the system of FIG. 1;

FIG. 4 is a simplified flow diagram of at least one embodiment of a method for performance monitoring of the cloud computing infrastructure that may be executed by the network controller of FIG. 3;

FIG. 5 is a simplified flow diagram of at least one embodiment of a method for creating an underlay network in the cloud computing infrastructure that may be executed by the network controller of FIG. 3; and

FIG. 6 is a simplified flow diagram of at least one embodiment of a method for configuring the underlay network created in FIG. 5 that may be executed by the network controller of FIG. 3.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one of A, B, and C” can mean (A); (B); (C): (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media (e.g., memory, data storage, etc.), which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

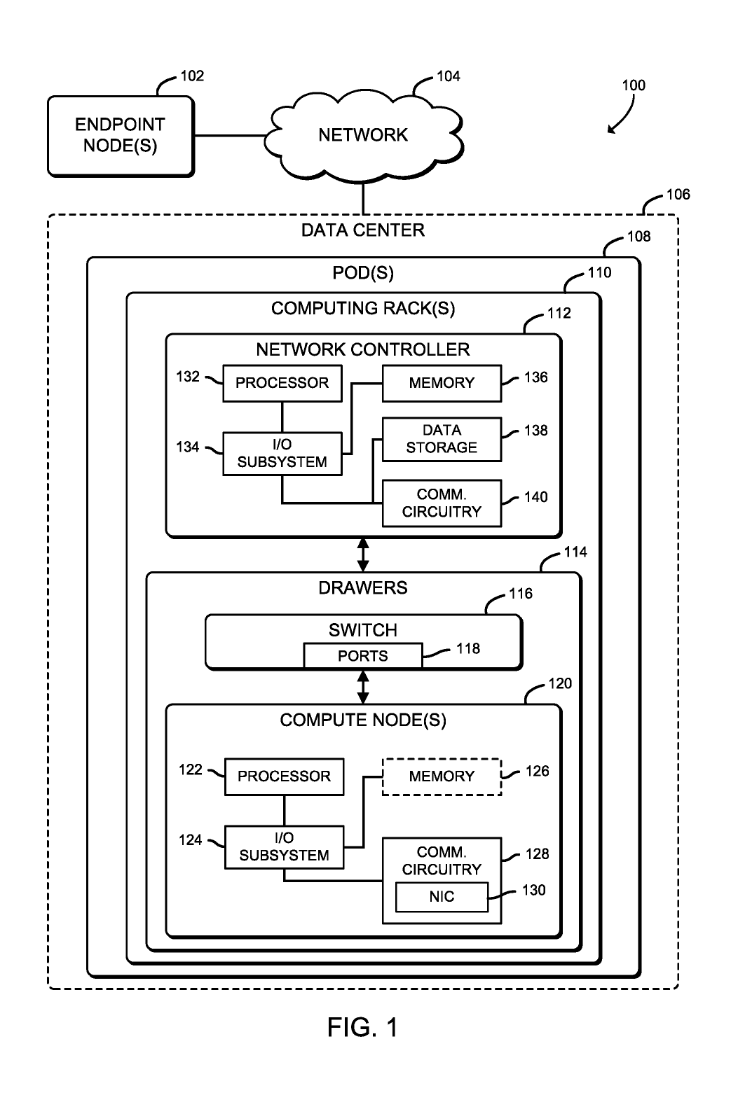

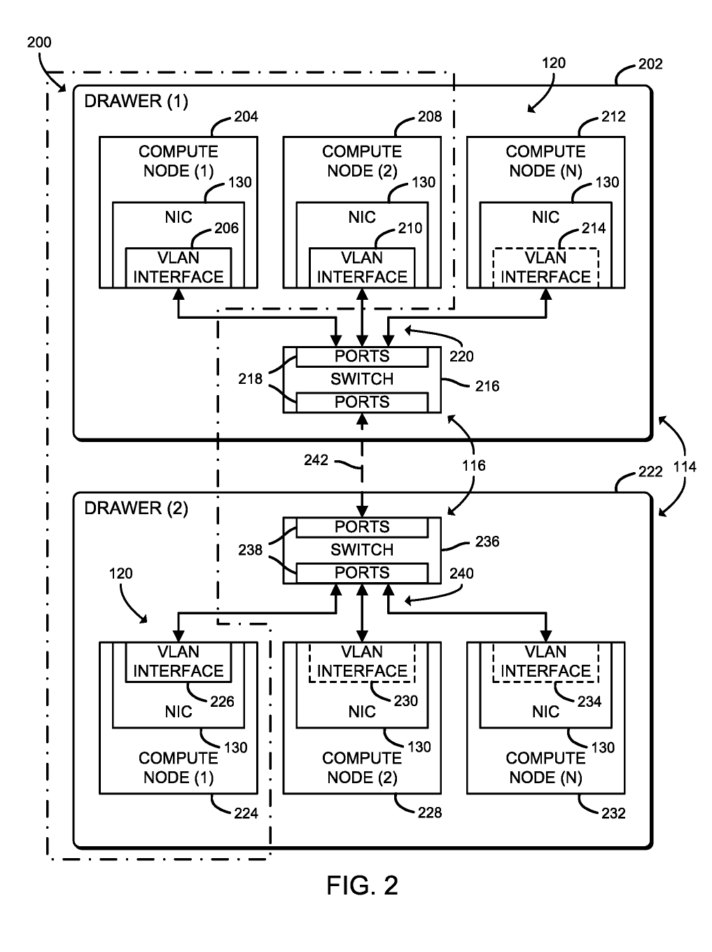

Referring now to FIG. 1, an illustrative system 100 for deploying dynamic underlay networks in a cloud computing infrastructure using a rack-scale computing architecture includes one or more endpoint nodes 102 communicatively coupled to an illustrative data center 106 including one or more pods 108 (i.e., collections of computing racks 110 within a shared infrastructure management domain). Each of the illustrative computing racks 120 includes a network controller 112 communicatively coupled to one or more drawers 114, or module enclosures, for housing a switch 116 and one or more compute nodes 120. In use, the network controller 112 manages the switches 116 of each of the drawers 114 to manage the provisioning and configuration of underlay networks (see, e.g., the underlay network 200 of FIG. 2).

Accordingly, under the direction of the network controller 112, the switches 116 can dynamically provision the underlay networks by forming virtual local area network (VLANs) between the respective switches 116 (i.e., those switches 116 associated with particular compute nodes 120 of a tenant network), effectively isolating tenant networks in the cloud environment. Upon creation of the underlay network, a virtualization layer of the network (i.e., an overlay network) can be created, made visible to a cloud operating system, managed using known technologies (e.g., the OpenDaylight platform via modular layer 2 (ML2) plugins, Ryu, Floodlight, etc.), and associated with the underlay network. Accordingly, the cloud operating system can manage host/instance visibility, scheduling, performance monitoring, and quality of service control over the underlay network. Further, the network controller 112 is configured to monitor performance levels of the switches 116 and the physical/virtual network interfaces of the compute nodes 120. Accordingly, the network controller 112 can orchestrate scheduling based on performance metrics (e.g., network usage, quality of service telemetry, etc.) and dynamically adjust the underlay network as necessary to address quality of service demands. While the illustrative system 100 includes disaggregated hardware (i.e., pooled drawers of compute, memory, and storage), it should be appreciated that the functions described herein may be performed on standard rack-mount servers, in other embodiments.

The endpoint nodes 102 may be embodied as any type of computation or computer device capable of performing the functions described herein, including, without limitation, a portable computing device (e.g., smartphone, tablet, laptop, notebook, wearable, etc.) that includes mobile hardware (e.g., processor, memory, storage, wireless communication circuitry, etc.) and software (e.g., an operating system) to support a mobile architecture and portability, a computer, a server (e.g., stand-alone, rack-mounted, blade, etc.), a network appliance (e.g., physical or virtual), a web appliance, a distributed computing system, a processor-based system, and/or a multiprocessor system.

The network 104 may be embodied as any type of wired and/or wireless communication network, including a wireless local area network (WLAN), a wireless personal area network (WPAN), a cellular network (e.g., Global System for Mobile Communications (GSM), Long-Term Evolution (LTE), etc.), a telephony network, a digital subscriber line (DSL) network, a cable network, a local area network (LAN), a wide area network (WAN), a global network (e.g., the Internet), or any combination thereof. It should be appreciated that, in such embodiments, the network 104 may serve as a centralized network and, in some embodiments, may be communicatively coupled to another network (e.g., the Internet). Accordingly, the network 104 may include a variety of other network computing devices (e.g., virtual and physical routers, switches, network hubs, servers, storage devices, compute devices, etc.), as needed to facilitate communications between the endpoint nodes 102 and the data center 106, as well as networking devices between data centers 106, which are not shown to preserve clarity of the description.

In use, the computing racks 110 transmit and receive data with other computing racks 110 in the same pod 108 and/or remote computing racks 110 in other pods 108 (e.g., over the network 104). To do so, each of the computing racks 110 may include a rack management controller (not shown) that is responsible for managing resources of the respective computing rack 110, such as power and cooling. Similarly, it should be appreciated that the rack management controllers may communicate with controllers of the pod 108, such as a pod management controller (not shown) configured to manage logical management functionality across all infrastructure within a respective pod 108.

The computing racks 110 may be embodied as modular computing devices that, alone or in combination with other computing racks 110, are capable of performing the functions described herein. For example, each of the computing racks 110 may be embodied as a chassis or other enclosure for rack-mounting modular computing units such as compute trays, storage trays, network trays, or traditional rack-mounted components such as servers and/or switches. As shown in FIG. 1, the illustrative computing rack 110 includes the one or more drawers 114 for housing the switch 116 and pooled computing resources (i.e., the compute nodes 120). The computing racks 110 may also include additional pooled system resources, such as pooled memory, pooled storage, and pooled networking, as well as associated interconnects, peripheral devices, power supplies, thermal management systems, and other components. Additionally, although illustrated as including drawer-level switches (e.g., the switch 116), the computing racks 110 may additionally and/or alternatively include a top-of-rack (ToR) switch, an edge-of-rack (EoR) switch, a middle-of-rack (MoR) switch, or any other type of disaggregated switch, in some embodiments. Further, it should be understood that, in some embodiments, the computing racks 110 may include more than one of each of the pooled system resources and/or disaggregated switching devices.

As described previously, the network controller 112 is illustratively deployed at the computing rack 110 level. However, in some embodiments, the network controller 112 may be incorporated at the pod 108 level of the data center 106, rather than the computing rack 110 level. The network controller 112 embodied as any type of network computing device (e.g., network traffic managing, processing, and/or forwarding device) capable of performing the functions described herein, such as, without limitation, a switch (e.g., rack-mounted, standalone, fully managed, partially managed, full-duplex, and/or half-duplex communication mode enabled, etc.), a server (e.g., stand-alone, rack-mounted, blade, etc.), a network appliance (e.g., physical or virtual), a router, a web appliance, a distributed computing system, a processor-based system, and/or a multiprocessor system.

As shown in FIG. 1, the illustrative network controller 112 includes a processor 132, an input/output (I/O) subsystem 134, a memory 136, a data storage device 138, and communication circuitry 140. Of course, the network controller 112 may include other or additional components, such as those commonly found in a network computing device, in other embodiments. Additionally, in some embodiments, one or more of the illustrative components may be incorporated in, or otherwise form a portion of, another component. For example, the memory 136, or portions thereof, may be incorporated in the processor 132 in some embodiments. Further, in some embodiments, one or more of the illustrative components may be omitted from the network controller 112.

The processor 132 may be embodied as any type of processor capable of performing the functions described herein. For example, the processor 132 may be embodied as a single or multi-core processor(s), digital signal processor, microcontroller, or other processor or processing/controlling circuit. Similarly, the memory 136 may be embodied as any type of volatile or non-volatile memory or data storage capable of performing the functions described herein. In operation, the memory 136 may store various data and software used during operation of the network controller 112, such as operating systems, applications, programs, libraries, and drivers.

The memory 136 is communicatively coupled to the processor 132 via the I/O subsystem 134, which may be embodied as circuitry and/or components to facilitate input/output operations with the processor 132, the memory 136, and other components of the network controller 112. For example, the I/O subsystem 134 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 134 may form a portion of a system-on-a-chip (SoC) and be incorporated, along with the processor 132, the memory 136, and other components of the network controller 112, on a single integrated circuit chip.

The data storage device 138 may be embodied as any type of device or devices configured for short-term or long-term storage of data such as, for example, memory devices and circuits, memory cards, hard disk drives, solid-state drives, or other data storage devices. It should be appreciated that the data storage device 138 and/or the memory 136 (e.g., the computer-readable storage media) may store various data as described herein, including operating systems, applications, programs, libraries, drivers, instructions, etc., capable of being executed by a processor (e.g., the processor 132) of the network controller 112.

The communication circuitry 140 may be embodied as any communication circuit, device, or collection thereof, capable of enabling communications between the network controller 112 and other computing devices, such as the switches 116 of the drawers 114, as well as a remote network computing device (e.g., another network controller, a load balancing network switch/router, an aggregated network switch, etc.) over a network (e.g., the network 104). The communication circuitry 140 may be configured to use any one or more communication technologies (e.g., wireless or wired communication technologies) and associated protocols (e.g., Ethernet, Bluetooth®, Wi-Fi®, WiMAX, LTE, 5G, etc.) to effect such communication.

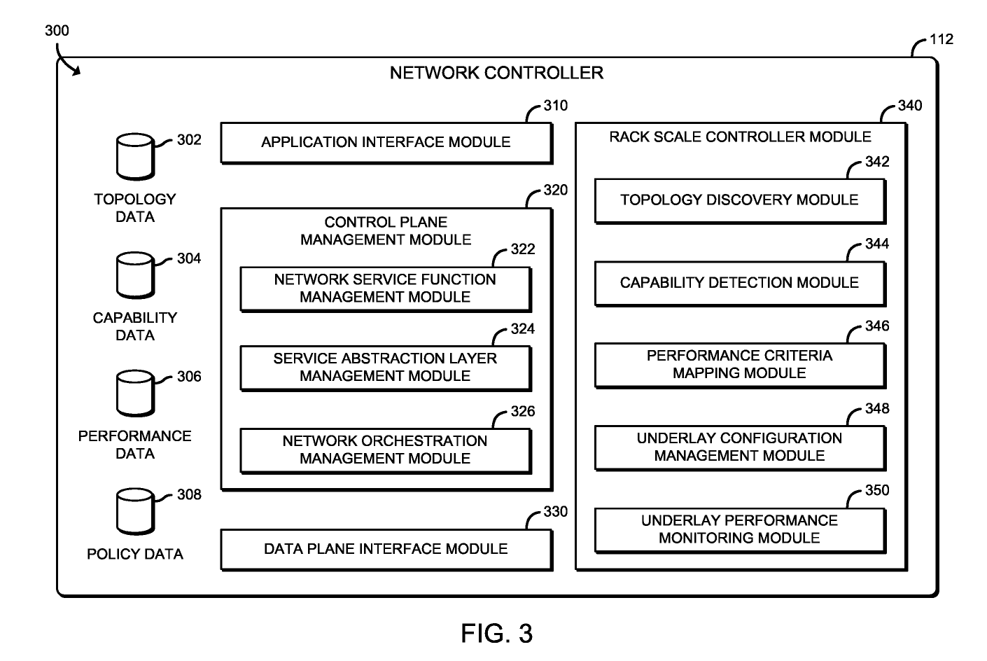

In some embodiments, the network controller 112 may be configured to operate in a software-defined networking (SDN) environment (i.e., an SDN controller) and/or a network functions virtualization (NFV) environment (i.e., an NFV manager and network orchestrator (MANO)). Accordingly, it should be appreciated that, in some embodiments, control functionality of the network controller 112 and placement within the data center 106 architecture may be dependent on the presence of a network/switch management module (see, e.g., the control plane management module 320 of FIG. 3) hosted on the network computing device described herein as the network controller 112. For example, the network controller 112 may be hosted in a network computing device as described above (e.g., a ToR switch, an EoR switch, a MoR switch, or any other type of disaggregated switch), an enhanced network interface controller (NIC) (e.g., a host fabric interface (HFI)), or any other computing device in the same management network at an entry port of a corresponding computing rack 110, such that the network controller 112 can communicate with all of the switches in a corresponding pod 108 or computing rack 110, depending on the embodiment.

The drawers 114 may be embodied as any chassis, tray, module, or other enclosure capable of supporting the switch 116 and the compute nodes 120, as well as any associated interconnects, power supplies, thermal management systems, or other associated components. It should be appreciated that each of the drawers 114 may include multiple modules including multiple slots for the insertion of a blade (e.g., a compute blade) within each slot. For example, in an illustrative embodiment, the drawers 114 may include multiple modules in which the switch 116 and/or blades (i.e., multiple compute blades pooled to form the compute nodes 120) may be inserted. It should be appreciated that, in some embodiments, each of the drawers 114 may additionally include a drawer management controller (not shown) for managing configuration of shared and pooled resources (e.g., memory, storage, compute, etc.) of the respective drawer 114. In such embodiments, the drawer management controller may be configured to interface with one or more of a pod management controller, a rack management controller, and/or any other managing controller (e.g., at the module level, the blade level, etc.).

The switch 116 may be embodied as any rack scale architecture compliant switch capable of performing the functions described herein, such as a module-based switch (i.e., for insertion into a module of a drawer 114), a ToR switch, an EoR switch, a MoR switch, or any type of disaggregated switch. For example, in some embodiments, the switch 116 may be configured as a managed smart switch that includes a set of management features, such as may be required for the switch 116 to provision the underlay networks (e.g., configuring VLANs) and perform other functions as described herein. The illustrative switch 116 includes multiple switch ports 118 (i.e., access ports) for transmitting and receiving data to/from the switch 116. Accordingly, the switch 116 is configured to create a separate collision domain for each of the switch ports 118. As such, depending on the network design of the switch and the operation mode (e.g., half-duplex, full-duplex, etc.), each compute node 120 connected to one of the switch ports 118 of the switch 116 can transfer data to any of the other compute nodes 120 at any given time, and the transmissions should not interfere, or collide.

Each compute node 120 may be embodied as any type of compute device capable of performing the functions described herein. For example, each of the compute nodes 120 may be embodied as, without limitation, one or more server computing devices, computer mainboards, daughtercards, or expansion cards, system-on-a-chips, computer processors, consumer electronic devices, smart appliances, and/or any other computing device or collection of devices capable of processing network communication. As shown in FIG. 1, the illustrative compute node 120 includes a processor 122, an I/O subsystem 124, communication circuitry 128, and, in some embodiments, may include memory 126. Of course, it should be appreciated that the compute node 120 may include other or additional components, such as those commonly found in a computing device (e.g., various input/output devices), in other embodiments. Additionally, in some embodiments, one or more of the illustrative components may be incorporated in, or otherwise from a portion of, another component. For example, the memory 126, or portions thereof, may be incorporated in the processor 122 in some embodiments.

The processor 122 may be embodied as any type of processor capable of performing the functions described herein. For example, the processor 122 may be embodied as a single or multi-core processor(s), digital signal processor, microcontroller, or other processor or processing/controlling circuit. Although illustratively shown as a single processor 122, in some embodiments, each compute node 120 may include multiple processors 122. Similarly, the I/O subsystem 124 may be embodied as circuitry and/or components to facilitate input/output operations with the processor 122, the communication circuitry 128, the memory 126, and other components of the compute node 120. For example, the I/O subsystem 124 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 124 may form a portion of a system-on-a-chip (SoC) and be incorporated, along with the processor 122, the communication circuitry 128, the memory 126, and other components of the compute node 120, on a single integrated circuit chip.

The memory 126 may be embodied as any type of volatile or non-volatile memory or data storage capable of performing the functions described herein. In operation, the memory 126 may store various data and software used during operation of the compute node 120 such as operating systems, applications, programs, libraries, and drivers. In some embodiments the memory 126 may temporarily cache or otherwise store data maintained by a memory pool. As shown, in some embodiments, the compute node 120 may not include any dedicated on-board memory 126.

The communication circuitry 128 may be embodied as any communication circuit, device, or collection thereof, capable of enabling communications between the compute node 120 and other compute nodes 120, the switch 116, and/or other remote devices. The communication circuitry 128 may be configured to use any one or more communication technology (e.g., wireless or wired communications) and associated protocols (e.g., Ethernet, Bluetooth®, Wi-Fi®, WiMAX, etc.) to effect such communication. In the illustrative embodiment, the communication circuitry 128 includes a NIC 130, usable to facilitate the transmission/reception of network packets with the switch 116.

The NIC 130 may be embodied as one or more add-in-boards, daughtercards, network interface cards, controller chips, chipsets, or other devices that may be used by the compute node 120. For example, in some embodiments, the NIC 130 may be integrated with the processor 122, embodied as an expansion card coupled to the I/O subsystem 124 over an expansion bus (e.g., PCI Express), part of an SoC that includes one or more processors, or included on a multichip package that also contains one or more processors. Additionally or alternatively, in some embodiments, functionality of the NIC 130 may be integrated into one or more components of the compute node 120 at the board level, socket level, chip level, and/or other levels.

It should be appreciated that underlay networks may span between compute nodes 120 connected to the same switch 116 (e.g., within the same drawer 114) or may span across multiple switches 116 (e.g., across multiple drawers 114). Referring now to FIG. 2, an illustrative underlay network 200 is shown spanning across a first drawer, designated as drawer (1) 202, and a second drawer, designated as drawer (2) 222 to connect three host compute nodes 120 as described herein. The first drawer (i.e., drawer (1) 202) includes a first compute node, which is designated as compute node (1) 204, a second compute node, which is designated as compute node (2) 208, and a third compute node, which is designated as compute node (N) 212 (i.e., the “Nth” compute node of the compute nodes 120 of the drawer (1) 202, wherein “N” is a positive integer and designates one or more additional compute nodes 120 of the drawer (1) 202). Similarly, the second drawer (i.e., drawer (2) 222) includes a first compute node, which is designated as compute node (1) 224, a second compute node, which is designated as compute node (2) 228, and a third compute node, which is designated as compute node (N) 232 (i.e., the “Nth” compute node of the compute nodes 120 of the drawer (2) 222, wherein “N” is a positive integer and designates one or more additional compute nodes 120 of the drawer (2) 222).

Each of the compute nodes 120 includes networking components capable of instantiating a VLAN interface over two or more physical network interfaces (i.e., the NICs 130 of each of the compute nodes 120), such as may be instantiated by using standard operating system commands. To do so, each of the drawers 114 additionally includes a switch 116, illustratively shown as switch 216 of drawer (1) 202 and switch 236 of drawer (2) 222, through which each of the compute nodes 120 can communicate to other compute nodes of the same drawer 114, as well as across different drawers 114. The communications between and/or across the drawers 114 is facilitated via switch ports 218 of the switch 216 and switch ports 238 of the switch 236 (e.g., via peripheral component interconnect express (PCIe) connections) along interconnect cables 220, 240.

The interconnect cables 220, 240 may be embodied as any high-speed communication links (i.e., point-to-point links, bus links, wires, cables, light guides, printed circuit board traces, etc.) capable of transferring data, such as may be manufactured using optical fiber, copper, or any other type of material capable of transferring data internal and/or external to the data center 106. Accordingly, it should be appreciated that, in some embodiments, the switches 216, 236 and/or the compute nodes 120 may include specialized NIC 130 circuitry, such as host fabric interfaces (HFIs), for interfacing with the interconnect cables 220, 240, as well as a silicon photonics switch fabric and a number of optical interconnects.

To create an underlay network, such as the illustrative underlay network 200 of FIG. 2, the network controller 112 is configured to transmit information (e.g., via application programming interface (API) commands) to the respective one or more switches 116 coupled to the applicable compute nodes 120 to be associated with the underlay network. Upon receipt of the instruction, the switch 116 can create a VLAN (i.e., add a VLAN reference to a database of the respective switch 116) and assign corresponding switch ports 118 to the created VLAN for interconnecting each of the switches 116. In some embodiments, a VLAN interface may be configured for the created VLAN on each switch 116, sometimes referred to as a switched virtual interface (SVI). Further, each of the compute nodes 120 to be assigned to the underlay network are configured to create a VLAN interface over a physical network interface device of the respective compute nodes (e.g., via the NICs 130).

In an illustrative example, the underlay network 200 of FIG. 2, indicated by a dashed boundary line, has been configured (e.g., by the network controller 112 of FIG. 1) to include the compute node (1) 204 and the compute node (2) 208 of drawer (1) 202, as well as the compute node (2) 224 of drawer (2) 228. In other words, the compute node (1) 204, the compute node (2) 208, and the compute node (2) 224 have each configured a VLAN interface (e.g., the VLAN interface 206 of the compute node (1) 204, the VLAN interface 210 of the compute node (2) 208, and the VLAN interface 226 of the compute node (1) 224) over their respective NIC 130. Additionally, to support intercommunications across the underlay network 200, multiple switch ports 218, 236 of the respective switches 216, 236 (e.g., two corresponding switch ports 218 of the switch 216 and one corresponding switch port 238 of the switch 236) have been configured to create a VLAN between the switches 216, 236. It should be appreciated that the other compute nodes 120 (e.g., the compute node (3) 212 of drawer (1) 202, and the compute node (2) 228 and the compute node (3) 232 of drawer (2) 222) not presently incorporated in the illustrative underlay network 200, may or may not have a configured VLAN interface (e.g., the VLAN interface 214 of the compute node (3) 212, the VLAN interface 230 of the compute node (2) 228, and the VLAN interface 234 of the compute node (3) 232) corresponding to another underlay network 200.

Referring now to FIG. 3, in an illustrative embodiment, the network controller 112 establishes an environment 300 during operation. The illustrative environment 300 includes an application interface module 310, a control plane management module 320, a data plane interface module 330, and a rack scale controller module 340. The various modules of the environment 300 may be embodied as hardware, firmware, software, or a combination thereof. As such, in some embodiments, one or more of the modules of the environment 300 may be embodied as circuitry or collection of electrical devices (e.g., an application interface circuit 310, a control plane management circuit 320, a data plane interface circuit 330, and a rack scale controller circuit 340, etc.).

It should be appreciated that, in such embodiments, one or more of the application interface circuit 310, the control plane management circuit 320, the data plane interface circuit 330, and the rack scale controller circuit 340 may form a portion of the one or more of the processor(s) 132, the I/O subsystem 134, the communication circuitry 140, and/or other components of the network controller 112. Additionally, in some embodiments, one or more of the illustrative modules may form a portion of another module and/or one or more of the illustrative modules may be independent of one another. Further, in some embodiments, one or more of the modules of the environment 300 may be embodied as virtualized hardware components or emulated architecture, which may be established and maintained by the one or more processors and/or other components of the network controller 112.

In the illustrative environment 300, the network controller 112 further includes topology data 302, capability data 304, performance data 306, and policy data 308, each of which may be stored in a memory and/or data storage device of the network controller 112. Further, each of the network topology data 302, the capability data 304, the performance data 306, and the policy data 308 may be accessed by the various modules and/or sub-modules of the network controller 112. Additionally, it should be appreciated that in some embodiments the data stored in, or otherwise represented by, each of the network topology data 302, the capability data 304, the performance data 306, and the policy data 308 may not be mutually exclusive relative to each other.

For example, in some implementations, data stored in the topology data 302 may also be stored as a portion of the capability data 304, and/or vice versa. As such, although the various data utilized by the network controller 112 is described herein as particular discrete data, such data may be combined, aggregated, and/or otherwise form portions of a single or multiple data sets, including duplicative copies, in other embodiments. It should be further appreciated that the network controller 112 may include additional and/or alternative components, sub-components, modules, sub-modules, and/or devices commonly found in a network computing device, which are not illustrated in FIG. 3 for clarity of the description.

It should be appreciated that control functionality may be different from one network controller to another. For example, different protocols (e.g., OpenFlow, OVSDB, etc.) may be used by different network controllers to communicate with other network computing devices (e.g., switches, routers, etc.) of the data center 106 and beyond. It should be further appreciated that additional network management services may be deployed in conjunction with the network controller 112 and communicatively coupled to the network controller 112 to create and manage virtual networks (i.e., network virtualization), such as OpenStack's Neutron that may be used to provide “networking as a service” between interface devices (e.g., virtual NICs) managed by other OpenStack services, which can be exposed to the network controller 112 (e.g., using OpenDaylight). In such embodiments, the network controller 112 may include a collection of agents, drivers, and/or plugins usable to perform different network tasks. Such network tasks can include discovery (e.g., topology, settings, capabilities, etc.) of the various network computing devices to which the network controller 112 is configured to manage, as well as performance monitoring (i.e., usage metrics, network statistics, etc.).

It should be appreciated that, unlike legacy internet protocol (IP) networks which use a gateway as the default router to access the Internet, in some embodiments (e.g., rack scale architecture embodiments including an SDN controller) the network controller 112 may rely on switches to connect a network (i.e., the compute nodes 120 via the switches 116) rather than routers, in some embodiments. As such, there may be no physical gateway router in the network of such embodiments, and the network controller 112 may rely instead on a virtual gateway. In an illustrative example, one or more dynamic host configuration protocol (DHCP) agents may be used to provide DHCP services to tenant networks, one or more L3 agents may be used to provide layer 3 and network address translation (NAT) forwarding to gain external access for virtual machines (VMs) instantiated on compute nodes 120 on tenant networks, and/or one or more dynamic network configuration and usage plugins may be deployed to support internal/external routing and DHCP services. Additionally, in some embodiments, extensions may be used to further enhance the functionality of the network controller 112 (i.e., to support additional capabilities), such as executable algorithms to yield analytic results, new policy orchestration throughout the network, etc.

The application interface module 310, which may be embodied as hardware, firmware, software, virtualized hardware, emulated architecture, and/or a combination thereof as discussed above, is configured to provide a network abstraction interface to applications and management systems at the top of the controller stack, such as may be provided via representational state transfer (REST) APIs (e.g., northbound APIs). In other words, the application interface module 310 is configured to facilitate communication between a particular component of the network and a higher-layer component, thereby enabling applications and/or orchestration systems to manage, or otherwise control, at least a portion of the network and to request services therefrom.

The control plane management module 320, which may be embodied as hardware, firmware, software, virtualized hardware, emulated architecture, and/or a combination thereof as discussed above, is configured to manage the control plane logic (e.g., logical to physical mapping, management of shared physical resources, etc.). To do so, the illustrative control plane management module 320 includes a network service function management module 322, a service abstraction layer management module 324, and a network orchestration management module 326. It should be appreciated that each of the network service function management module 322, the service abstraction layer management module 324, and the network orchestration management module 326 of the control plane management module 320 may be separately embodied as hardware, firmware, software, virtualized hardware, emulated architecture, and/or a combination thereof. For example, the network service function management module 322 may be embodied as a hardware component, while the service abstraction layer management module 324 and/or the network orchestration management module 326 may be embodied as a virtualized hardware component or as some other combination of hardware, firmware, software, virtualized hardware, emulated architecture, and/or a combination thereof.

The network service function management module 322 is configured to manage network service functions of the network controller 112. Accordingly, the network service function management module 322 is configured to manage based network service functions (e.g., discovery, topology management, statistical data management, host tracking, layer 2 switching, group-based policy management, service chain virtual network function (VNF) deployment, event notification, etc.), as well as third party network service functions as may be required. The service abstraction layer management module 324 is configured to manage the service abstraction layer (SAL). To do so, the service abstraction layer management module 324 is configured to manage plugins of the network controller 112, as well as perform capability abstraction/advertisement, flow programming, inventory, etc. The network orchestration management module 326 is configured to manage programmed automated behaviors in a network to coordinate the required networking resources (e.g., hardware, software, etc.) to support certain types of applications and services, such as may be interfaced with by communications received from the endpoint nodes 102. In other words, the network orchestration management module 326 is configured to monitor the network and automate connectivity.

The data plane interface module 330, which may be embodied as hardware, firmware, software, virtualized hardware, emulated architecture, and/or a combination thereof as discussed above, is configured to communicate with physical and virtual network devices (e.g., physical and virtual switches and routers), such as via REST APIs (e.g., southbound APIs) to configure, or otherwise define, the behavior of the network devices. In other words, the data plane interface module 330 is configured to facilitate communication between a particular network component and a lower-layer component. Accordingly, the data plane interface module 330 can discover network topology, define network flows, and implement requests relayed to it via the application interface module 310.

The rack scale controller module 340, which may be embodied as hardware, firmware, software, virtualized hardware, emulated architecture, and/or a combination thereof as discussed above, is configured to manage a rack scale pooled system environment, and more particularly the underlay networks. In some embodiments, the rack scale controller module 340 may be configured to utilize plugins, drivers, and/or agents hosted on the network controller 112 to manage the rack scale pooled system environment, such that the network controller 112 can manage various aspects of the network, including network traffic/flow engineering, quality of service management, resource coordination, resource optimization, etc. In such embodiments, the utilize plugins, drivers, and/or agents may be configured to interface with one or more of the other modules of the network controller 112 (e.g., the application interface module 310, the control plane management module 320, and/or the data plane interface module 330).

To manage the underlay networks, the illustrative rack scale controller module 340 includes a topology discovery module 342, a capability detection module 344, a performance criteria mapping module 346, an underlay configuration management module 348, and an underlay performance monitoring module 350. It should be appreciated that each of the topology discovery module 342, the capability detection module 344, and the performance criteria mapping module 346 of the rack scale controller module 340 may be separately embodied as hardware, firmware, software, virtualized hardware, emulated architecture, and/or a combination thereof. For example, the topology discovery module 342 may be embodied as a hardware component, while the capability detection module 344 and/or another of the submodules may be embodied as a virtualized hardware component or as some other combination of hardware, firmware, software, virtualized hardware, emulated architecture, and/or a combination thereof.

The topology discovery module 342 is configured to discover the physical and virtual network resources, including the compute nodes 120 and other elements of the network, as well as a topology of the network resources. To do so, the topology discovery module 342 is configured to interface with the applicable switches of the network (e.g., the switches 116). In some embodiments, the topology information discovered by the topology discovery module 342 may be stored in the topology data 302. The capability detection module 344 is configured to detect or otherwise discover capabilities of the compute nodes 120 and other elements of the network. To do so, the capability detection module 344 is configured to detect physical and virtual resource capabilities. In some embodiments, the capability information detected by the capability detection module 344 may be stored in the capability data 304.

The performance criteria mapping module 346 is configured to define network performance criteria based on an input from an end user and map the performance criteria to physical properties of the network components (e.g., the switch ports 118 of the switches 116, the compute nodes 120, etc.). For example, the performance criteria mapping module 346 may be configured to use virtual hardware templates (e.g., flavors in OpenStack), which define resources to be allocated, such as a sizes for RAM, disk, number of process cores, etc. In some embodiments, the performance criteria mapping module 346 may be configured to retrieve information usable to define the performance criteria using out-of-band communication channels. In some embodiments, the information usable to define the performance criteria and/or the performance criteria defined by the performance criteria mapping module 346 may be stored in the performance data 306. Additionally, in some embodiments, the performance criteria may be determined from a policy, such as a service level agreement (SLA). In such embodiments, the policy, or information related thereto, may be stored in the policy data 308.

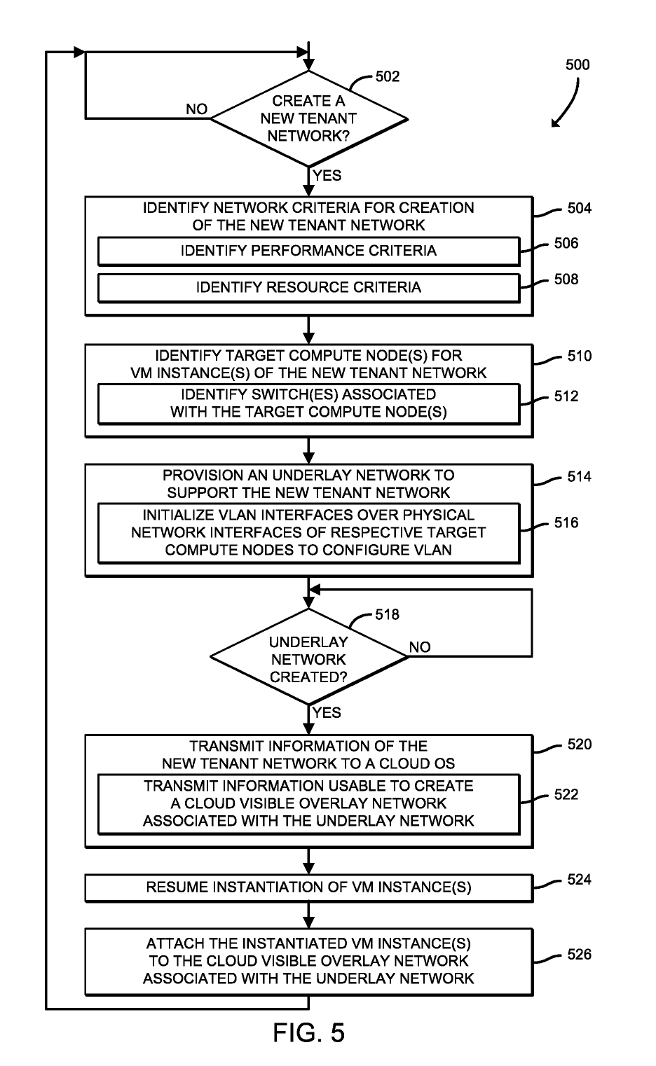

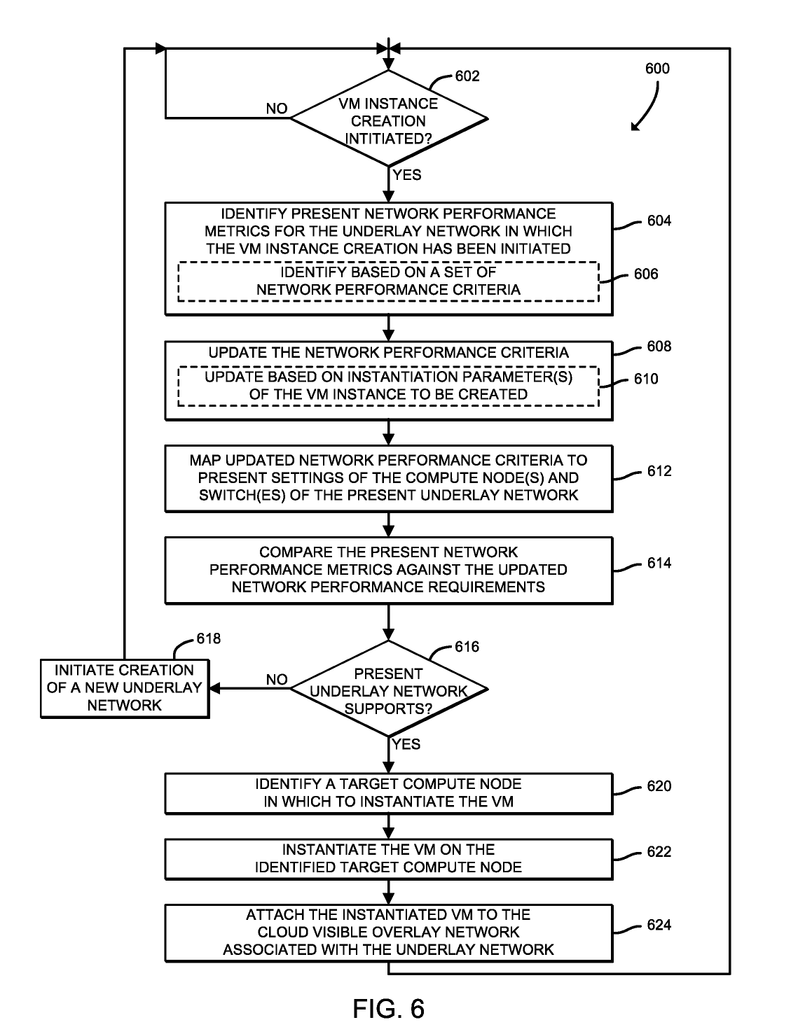

The underlay configuration management module 348 is configured to dynamically create underlay networks (see, e.g., the methods 500 and 600 of FIG. 5 and FIG. 6, respectively). Accordingly, the underlay configuration management module 348 is configured to access hardware controls (e.g., via hardware APIs) and/or utilize software APIs to dynamically create/modify the underlay networks, such as may be accessed via the network orchestration management module 326. For example, the underlay configuration management module 348 may be configured to manage VLAN interface configuration and/or switch ports of the switches (e.g., the switch ports 118 of the switches 116 of FIG. 1) as necessary to dynamically create/modify the underlay networks.

The underlay performance monitoring module 350 is configured to monitor performance of the underlay networks to determine performance metrics of the underlay networks. To do so, the underlay performance monitoring module 350 may be configured to monitor the physical and/or virtual network interfaces of the switches 116 and the compute nodes 120. In some embodiments, the underlay performance monitoring module 350 may be configured to monitor performance metrics of the underlay networks using out-of-band communication channels. The performance metrics may include any data indicative of a performance level of the underlay network, such as usage statistics, quality of service telemetry data, etc. In some embodiments, the performance metrics captured by the underlay performance monitoring module 350 may be stored in the performance data 306.

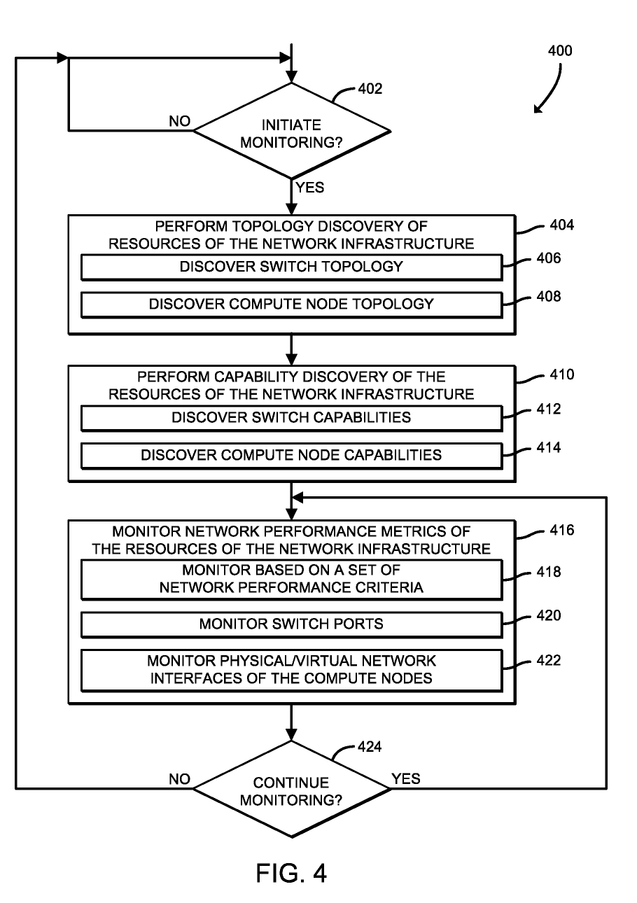

Referring now to FIG. 4, in use, the network controller 112 may execute a method 400 for performance monitoring of a cloud computing infrastructure. The method 400 begins in block 402, in which the network controller 112 determines whether to initiate performance monitoring (e.g., quality of service monitoring) of the network resources for which the network controller 112 is configured to manage. If so, the method 400 advances to block 404, in which the network controller 112 discovers the topology of the underlying network infrastructure. For example, in block 406, the network controller 112 discovers the topology of the switches (e.g., the switches 116) of the underlying network infrastructure. Additionally or alternatively, in block 408, the network controller 112 discovers the topology of the compute nodes (e.g., the compute nodes 120) of the underlying network infrastructure.

In block 410, the network controller 112 performs a capability discovery of the resources (e.g., physical and virtual) of the underlying network infrastructure. For example, in block 412, the network controller 112 discovers capabilities of the switches (e.g., the switches 116). Additionally or alternatively, in block 414, the network controller 112 discovers capabilities of the compute nodes (e.g., the compute nodes 120). In block 416, the network controller 112 monitors network performance metrics of the resources (e.g., physical and virtual) of the underlying network infrastructure. To do so, in block 418, the network controller 112 monitors the network performance metrics based on a set of network performance criteria. In some embodiments, the network performance criteria may be set by an end user (e.g., an administrator of the network, a user of a cloud-based application being accessed from one of the endpoint nodes 102, etc.), such as may be performed in compliance with an SLA. For example, in block 420, the network controller 112 monitors the switch ports of the switches (e.g., the switch ports 118 the switches 116) of the underlying network infrastructure. Additionally or alternatively, in block 422, the network controller 112 monitors physical (e.g., NICs) and/or virtual (VLAN) interfaces of the compute nodes (e.g., the compute nodes 120) of the underlying network infrastructure.

In block 424, the network controller 112 determines whether to continue performance monitoring of the cloud computing infrastructure. If so, the method 400 returns to block 416, in which the network controller 112 continues to monitor network performance metrics of the resources (e.g., physical and virtual) of the underlying network infrastructure. Otherwise, if the network controller 112 determines not to continue performance monitoring of the cloud computing infrastructure, the method 400 returns to block 402, in which the network controller 112 again determines whether to initiate performance monitoring (e.g., quality of service monitoring) of the network resources for which the network controller 112 is configured to manage.

Referring now to FIG. 5, in use, the network controller 112 may execute a method 500 for creating an underlay network in a cloud computing infrastructure. The method 500 begins in block 502, in which the network controller 112 determines whether to create a new tenant network in the cloud computing infrastructure. For example, the network controller 112 may receive a tenant network creation request from a cloud networking operating system (e.g., at the cloud networking layer) that a virtual network is to be created. If so, the method 500 advances to block 504, in which the network controller 112 identifies network criteria for the creation of the new tenant network. The network criteria may be any data usable to identify potential resources of the physical network which may be used to create the new tenant network. For example, in block 506, the network controller 112 identifies any performance criteria required to support the new tenant network, such as usage thresholds, quality of service requirements, etc. Additionally, in block 508, the network controller 112 identifies any resource criteria required to support the new tenant network, such as compute availability, memory availability, storage availability, etc.

In block 510, the network controller 112 identifies one or more target compute nodes (e.g., one or more of the compute nodes 120 of FIG. 1) in which to instantiate one or more VMs for the new tenant network. Additionally, the block 512, the network controller 112 identifies one or more switches (e.g., one or more of the switches 116) associated with the one or more target compute nodes identified in block 510. In block 514, the network controller 112 provisions an underlay network to support the new tenant network. To do so, in block 516, the network controller 112 initializes one or more VLAN interfaces over physical network interfaces of the respective target compute nodes to configure a VLAN to be associated with the new tenant network.

In block 518, the network controller 112 determines whether the underlay network has been successfully created. If so, the method 500 advances to block 520, in which the network controller 112 transmits information regarding the new tenant network to the cloud operating system from which the tenant network creation request was received in block 502. For example, in block 522, the network controller 112 transmits information to the cloud operating system that is usable to create a cloud visible overlay network (i.e., the virtual network) associated with the underlay network created in block 518. To do so, in some embodiments, the information may be transmitted to the virtual network through an Open vSwitch Database Management Protocol (OVSDB) plugin, or any equivalent physical to virtual bridge plugin in other embodiments. In block 524, the network controller 112 resumes instantiation/provisioning of the VM instances of the new tenant network. In block 526, the network controller 112 attaches the instantiated VM instances to the cloud visible overlay network created by the cloud OS (i.e., based on the information transmitted in block 520).

Referring now to FIG. 6, in use, the network controller 112 may execute a method 600 for configuring an underlay network created in a cloud computing infrastructure. The method 600 begins in block 602, in which the network controller 112 determines whether a VM instance creation has been initiated for an existing underlay network (i.e., for creation on a host compute node 120). If so, the method 600 advances to block 604, in which the network controller 112 identifies present network performance metrics for the underlay network. To do so, in block 606, the network controller 112 identifies the network performance metrics based on a set of network performance criteria (e.g., a set of quality of service requirements as defined by an SLA or directed by an application/service).

In block 608, the network controller 112 updates the network performance criteria. To do so, in block 610, the network controller 112 updates the network performance criteria based on one or more instantiation parameters for the VM instance to be created. In block 612, the network controller 112 maps the network performance criteria updated in block 608 to present settings of the compute nodes 120 and corresponding switches 116 of the present underlay network. In block 614, the network controller 112 compares the present network performance metrics identified in block 604 against the updated network performance criteria.

In block 616, the network controller 112 determines whether the present underlay network can support the updated network performance criteria based on the comparison in block 614. If not, the method 600 branches to block 618, in which the network controller 112 initiates creation of a new underlay network (see, e.g., the method 500 of FIG. 5); otherwise, the method branches to block 620. In block 620, the network controller 112 identifies a target compute node in which to instantiate the VM, such as may be determined based on the comparison performed in block 614. In block 622, the network controller 112 instantiates the VM on the target compute node identified in block 620. In block 624, the network controller 112 attaches the VM instantiated on the target compute node in block 622 to the cloud visible overlay network associated with the underlay network.

It should be appreciated that a cloud network service, such as Neutron, may update the underlay network information on the network controller 112 and/or the compute nodes 120, as well as create a virtual network that may be exposed while creating the underlay network instance. It should be further appreciated that, in some embodiments, one or more of the methods 400, 500, and 600 may be embodied as various instructions stored on a computer-readable media, which may be executed by a processor (e.g., the processor 132), the communication circuitry 140, and/or other components of the network controller 112 to cause the network controller 112 to perform the methods 400, 500, and 600. The computer-readable media may be embodied as any type of media capable of being read by the network controller 112 including, but not limited to, the memory 136, the data storage device 138, other memory or data storage devices of the network controller 112, portable media readable by a peripheral device of the network controller 112, and/or other media.

### Examples

Illustrative examples of the technologies disclosed herein are provided below. An embodiment of the technologies may include any one or more, and any combination of, the examples described below.

Example 1 includes a network controller for deploying dynamic underlay networks in a cloud computing infrastructure, the network controller comprising one or more processors; and one or more memory devices having stored therein a plurality of instructions that, when executed by the one or more processors, cause the network controller to receive, from a cloud operating system of the cloud computing infrastructure, a tenant network creation request that indicates a tenant network is to be created in the cloud computing infrastructure for a new tenant of the cloud computing infrastructure; identify network criteria for the tenant network based on the received tenant network creation request; identify physical resources of the cloud computing infrastructure usable to create the tenant network based on the identified network criteria; provision an underlay network to support the tenant network based on the identified physical resources; and transmit information of the underlay network to the cloud operating system, wherein the information of the underlay network is usable to create a cloud visible overlay network associated with the underlay network.

Example 2 includes the subject matter of Example 1, and wherein to identify the physical resources of the cloud computing infrastructure comprises to (i) identify one or more target compute nodes for instantiation of one or more virtual machines to be associated with the tenant network and (ii) identify one or more switches coupling the one or more identified target compute nodes to the cloud computing infrastructure.

Example 3 includes the subject matter of any of Examples 1 and 2, and wherein to provision the underlay network comprises to (i) initialize a virtual local area network (VLAN) interface over a physical network interface of the one or more identified target compute nodes and (ii) configure switch ports of the one or more switches to configure a VLAN between the one or more switches.

Example 4 includes the subject matter of any of Examples 1-3, and wherein to provision the underlay network comprises to invoke rack scale architecture compliant application programming interface commands to the one or more switches.

Example 5 includes the subject matter of any of Examples 1-4, and wherein to receive the tenant network creation request comprises to receive an indication that one or more virtual machines are to be instantiated to support the tenant network, and wherein the plurality of instructions further cause the network controller to instantiate the one or more virtual machines at one or more target compute nodes of the cloud computing infrastructure; and attach the one or more instantiated virtual machines to the cloud visible overlay network associated with the underlay network.

Example 6 includes the subject matter of any of Examples 1-5, and wherein to identify the network criteria usable to create the tenant network comprises to identify at least one of a performance criterion or a resource criterion.

Example 7 includes the subject matter of any of Examples 1-6, and wherein the performance criterion includes at least one of a usage threshold or a quality of service requirement.

Example 8 includes the subject matter of any of Examples 1-7, and wherein the resource criterion includes at least one of a compute availability, memory availability, or storage availability.

Example 9 includes the subject matter of any of Examples 1-8, and wherein the plurality of instructions further cause the network controller to discover the physical resources of the cloud computing infrastructure, wherein to discover the physical resources comprises to discover at least one of a plurality of switches of the cloud computing infrastructure, capabilities of each of the plurality of switches, a plurality of compute nodes of the cloud computing infrastructure, capabilities of each of the plurality of compute nodes, or a topology of the physical resources.

Example 10 includes the subject matter of any of Examples 1-9, and wherein the plurality of instructions further cause the network controller to monitor the physical resources based on the identified network criteria.

Example 11 includes the subject matter of any of Examples 1-10, and wherein to monitor the physical resources comprises to monitor at least one of one or more physical network interfaces of one or more of the plurality of compute nodes, one or more virtual network interfaces of one or more of the plurality of compute nodes, or one or more switch ports of one or more of the plurality of switches.

Example 12 includes the subject matter of any of Examples 1-11, and wherein to identify the physical resources of the cloud computing infrastructure usable to create the tenant network is further based on a result of the monitored physical resources.

Example 13 includes the subject matter of any of Examples 1-12, and wherein the plurality of instructions further cause the network controller to identify present network performance metrics for the underlay network based on a result of the monitored physical resources.

Example 14 includes the subject matter of any of Examples 1-13, and wherein the plurality of instructions further cause the network controller to (i) receive an indication of a virtual machine instance to be instantiated in the underlay network, (ii) identify one or more present network performance metrics of the underlay network, (iii) update network performance criteria associated with monitoring performance levels of the underlay network, (iv) compare the one or more present network performance metrics and the updated network performance criteria, and (v) determine whether the underlay network can support instantiation of the virtual machine instance.

Example 15 includes the subject matter of any of Examples 1-14, and wherein the plurality of instructions further cause the network controller to initiate, in response to a determination that the underlay network cannot support instantiation of the virtual machine instance, creation of a new underlay network that includes the virtual machine instance to be instantiated.

Example 16 includes the subject matter of any of Examples 1-15, and wherein the plurality of instructions further cause the network controller to (i) identify, in response to a determination that the underlay network can support instantiation of the virtual machine instance, a target compute node in which to instantiate the virtual machine instance, (ii) instantiate the virtual machine instance on the identified target compute node, and (iii) attach the instantiated virtual machine instance to the cloud visible overlay network associated with the underlay network.

Example 17 includes a network controller for deploying dynamic underlay networks in a cloud computing infrastructure, the network controller comprising an application interface circuit to receive a tenant network creation request from a cloud operating system of the cloud computing infrastructure, wherein the tenant network creation request indicates a tenant network is to be created in the cloud computing infrastructure for a new tenant of the cloud computing infrastructure; and a rack scale controller circuit to (i) identify network criteria for the tenant network based on the received tenant network creation request, (ii) identify physical resources of the cloud computing infrastructure usable to create the tenant network based on the identified network criteria, (iii) provision an underlay network to support the tenant network based on the identified physical resources, and (iv) transmit information of the underlay network to the cloud operating system, wherein the information of the underlay network is usable to create a cloud visible overlay network associated with the underlay network.

Example 18 includes the subject matter of Example 17, and wherein to identify the physical resources of the cloud computing infrastructure comprises to (i) identify one or more target compute nodes for instantiation of one or more virtual machines to be associated with the tenant network and (ii) identify one or more switches coupling the one or more identified target compute nodes to the cloud computing infrastructure.

Example 19 includes the subject matter of any of Examples 17 and 18, and wherein to provision the underlay network comprises to (i) initialize a virtual local area network (VLAN) interface over a physical network interface of the one or more identified target compute nodes and (ii) configure switch ports of the one or more switches to configure a VLAN between the one or more switches.

Example 20 includes the subject matter of any of Examples 17-19, and wherein to provision the underlay network comprises to invoke rack scale architecture compliant application programming interface commands to the one or more switches.

Example 21 includes the subject matter of any of Examples 17-20, and wherein to receive the tenant network creation request comprises to receive an indication that one or more virtual machines are to be instantiated to support the tenant network, and further comprising a data plane interface circuit to instantiate the one or more virtual machines at one or more target compute nodes of the cloud computing infrastructure, wherein the rack scale controller circuit is further to attach the one or more instantiated virtual machines to the cloud visible overlay network associated with the underlay network.

Example 22 includes the subject matter of any of Examples 17-21, and wherein to identify the network criteria usable to create the tenant network comprises to identify at least one of a performance criterion or a resource criterion.

Example 23 includes the subject matter of any of Examples 17-22, and wherein the performance criterion includes at least one of a usage threshold or a quality of service requirement.

Example 24 includes the subject matter of any of Examples 17-23, and wherein the resource criterion includes at least one of a compute availability, memory availability, or storage availability.

Example 25 includes the subject matter of any of Examples 17-24, and wherein the rack scale controller circuit is further to discover the physical resources of the cloud computing infrastructure, wherein to discover the physical resources comprises to discover at least one of a plurality of switches of the cloud computing infrastructure, capabilities of each of the plurality of switches, a plurality of compute nodes of the cloud computing infrastructure, capabilities of each of the plurality of compute nodes, or a topology of the physical resources.

Example 26 includes the subject matter of any of Examples 17-25, and wherein the rack scale controller circuit is further to monitor the physical resources based on the identified network criteria.

Example 27 includes the subject matter of any of Examples 17-26, and wherein to monitor the physical resources comprises to monitor at least one of one or more physical network interfaces of one or more of the plurality of compute nodes, one or more virtual network interfaces of one or more of the plurality of compute nodes, or one or more switch ports of one or more of the plurality of switches.

Example 28 includes the subject matter of any of Examples 17-27, and wherein to identify the physical resources of the cloud computing infrastructure usable to create the tenant network is further based on a result of the monitored physical resources.

Example 29 includes the subject matter of any of Examples 17-28, and wherein the rack scale controller circuit is further to identify present network performance metrics for the underlay network based on a result of the monitored physical resources.

Example 30 includes the subject matter of any of Examples 17-29, and wherein the rack scale controller circuit is further to (i) receive an indication of a virtual machine instance to be instantiated in the underlay network, (ii) identify one or more present network performance metrics of the underlay network, (iii) update network performance criteria associated with monitoring performance levels of the underlay network, (iv) compare the one or more present network performance metrics and the updated network performance criteria, and (v) determine whether the underlay network can support instantiation of the virtual machine instance.

Example 31 includes the subject matter of any of Examples 17-30, and wherein the rack scale controller circuit is further to initiate, in response to a determination that the underlay network cannot support instantiation of the virtual machine instance, creation of a new underlay network that includes the virtual machine instance to be instantiated.

Example 32 includes the subject matter of any of Examples 17-31, and wherein the rack scale controller circuit is further to (i) identify, in response to a determination that the underlay network can support instantiation of the virtual machine instance, a target compute node in which to instantiate the virtual machine instance, (ii) instantiate the virtual machine instance on the identified target compute node, and (iii) attach the instantiated virtual machine instance to the cloud visible overlay network associated with the underlay network.

Example 33 includes a method for deploying dynamic underlay networks in a cloud computing infrastructure, the method comprising receiving, by a network controller in the cloud computing infrastructure, a tenant network creation request from a cloud operating system of the cloud computing infrastructure, wherein the tenant network creation request indicates to the network controller to create a new tenant network in the cloud computing infrastructure; identifying, by the network controller, network criteria for the new tenant network based on the received tenant network creation request; identifying, by the network controller, physical resources of the cloud computing infrastructure usable to create the new tenant network based on the identified network criteria; provisioning, by the network controller, an underlay network to support the new tenant network based on the identified physical resources; and transmitting, by the network controller, information of the underlay network to the cloud operating system, wherein the information of the underlay network is usable to create a cloud visible overlay network associated with the underlay network.

Example 34 includes the subject matter of Example 33, and wherein identifying the physical resources of the cloud computing infrastructure comprises (i) identifying one or more target compute nodes for instantiation of one or more virtual machines to be associated with the new tenant network and (ii) identifying one or more switches coupling the one or more identified target compute nodes to the cloud computing infrastructure.

Example 35 includes the subject matter of any of Examples 33 and 34, and wherein provisioning the underlay network comprises (i) initializing a virtual local area network (VLAN) interface over a physical network interface of the one or more identified target compute nodes and (ii) configuring switch ports of the one or more switches to configure a VLAN between the one or more switches.

Example 36 includes the subject matter of any of Examples 33-35, and wherein provisioning the underlay network comprises invoking rack scale architecture compliant application programming interface commands to the one or more switches.

Example 37 includes the subject matter of any of Examples 33-36, and wherein receiving the tenant network creation request comprises receiving an indication that one or more virtual machines are to be instantiated to support the new tenant network, and further comprising instantiating, by the network controller, the one or more virtual machines at one or more target compute nodes of the cloud computing infrastructure; and attaching, by the network controller, the one or more instantiated virtual machines to the cloud visible overlay network associated with the underlay network.

Example 38 includes the subject matter of any of Examples 33-37, and wherein identifying the network criteria usable to create the new tenant network comprises identifying at least one of a performance criterion or a resource criterion.

Example 39 includes the subject matter of any of Examples 33-38, and wherein identifying the performance criterion comprises identifying at least one of a usage threshold or a quality of service requirement.

Example 40 includes the subject matter of any of Examples 33-39, and wherein identifying the resource criterion comprises identifying at least one of a compute availability, memory availability, or storage availability.

Example 41 includes the subject matter of any of Examples 33-40, and further including discovering, by the network controller, the physical resources of the cloud computing infrastructure, wherein discovering the physical resources comprises discovering at least one of a plurality of switches of the cloud computing infrastructure, capabilities of each of the plurality of switches, a plurality of compute nodes of the cloud computing infrastructure, capabilities of each of the plurality of compute nodes, or a topology of the physical resources.

Example 42 includes the subject matter of any of Examples 33-41, and further including monitoring, by the network controller, the physical resources based on the identified network criteria.

Example 43 includes the subject matter of any of Examples 33-42, and wherein monitoring the physical resources comprises monitoring at least one of one or more physical network interfaces of one or more of the plurality of compute nodes, one or more virtual network interfaces of one or more of the plurality of compute nodes, or one or more switch ports of one or more of the plurality of switches.

Example 44 includes the subject matter of any of Examples 33-43, and wherein identifying the physical resources of the cloud computing infrastructure usable to create the new tenant network is further based on a result of the monitored physical resources.

Example 45 includes the subject matter of any of Examples 33-44, and further including identifying, by the network controller, present network performance metrics for the underlay network based on a result of the monitored physical resources.

Example 46 includes the subject matter of any of Examples 33-45, and further including receiving, by the network controller, an indication of a virtual machine instance to be instantiated in the underlay network; identifying, by the network controller, one or more present network performance metrics of the underlay network; updating, by the network controller, network performance criteria associated with monitoring performance levels of the underlay network; comparing, by the network controller, the one or more present network performance metrics and the updated network performance criteria; and determining, by the network controller, whether the underlay network can support instantiation of the virtual machine instance.

Example 47 includes the subject matter of any of Examples 33-46, and further including initiating, by the network controller and in response to a determination that the underlay network cannot support instantiation of the virtual machine instance, creation of a new underlay network that includes the virtual machine instance to be instantiated.

Example 48 includes the subject matter of any of Examples 33-47, and further including identifying, by the network controller and in response to a determination that the underlay network can support instantiation of the virtual machine instance, a target compute node in which to instantiate the virtual machine instance; instantiating, by the network controller, the virtual machine instance on the identified target compute node; and attaching, by the network controller, the instantiated virtual machine instance to the cloud visible overlay network associated with the underlay network.

Example 49 includes a network controller comprising a processor; and a memory having stored therein a plurality of instructions that when executed by the processor cause the network controller to perform the method of any of Examples 33-48.

Example 50 includes one or more machine readable storage media comprising a plurality of instructions stored thereon that in response to being executed result in a network controller performing the method of any of Examples 33-48.

Example 51 includes a network controller for deploying dynamic underlay networks in a cloud computing infrastructure, the network controller comprising an application interface circuit to receive a tenant network creation request from a cloud operating system of the cloud computing infrastructure, wherein the tenant network creation request indicates to the network controller to create a new tenant network in the cloud computing infrastructure; means for identifying network criteria for the new tenant network based on the received tenant network creation request; means for identifying physical resources of the cloud computing infrastructure usable to create the new tenant network based on the identified network criteria; and means for provisioning an underlay network to support the new tenant network based on the identified physical resources, means for transmitting information of the underlay network to the cloud operating system, wherein the information of the underlay network is usable to create a cloud visible overlay network associated with the underlay network.

Example 52 includes the subject matter of Example 51, and wherein the means for identifying the physical resources of the cloud computing infrastructure comprises means for (i) identifying one or more target compute nodes for instantiation of one or more virtual machines to be associated with the new tenant network and (ii) identifying one or more switches coupling the one or more identified target compute nodes to the cloud computing infrastructure.

Example 53 includes the subject matter of any of Examples 51 and 52, and wherein the means for provisioning the underlay network comprises means for (i) initializing a virtual local area network (VLAN) interface over a physical network interface of the one or more identified target compute nodes and (ii) configuring switch ports of the one or more switches to configure a VLAN between the one or more switches.

Example 54 includes the subject matter of any of Examples 51-53, and wherein the means for provisioning the underlay network comprises means for invoking rack scale architecture compliant application programming interface commands to the one or more switches.

Example 55 includes the subject matter of any of Examples 51-54, and wherein to receive the tenant network creation request comprises to receive an indication that one or more virtual machines are to be instantiated to support the new tenant network, and further comprising a data plane interface circuit to instantiate the one or more virtual machines at one or more target compute nodes of the cloud computing infrastructure; and means for attaching the one or more instantiated virtual machines to the cloud visible overlay network associated with the underlay network.

Example 56 includes the subject matter of any of Examples 51-55, and wherein the means for identifying the network criteria usable to create the new tenant network comprises means for identifying at least one of a performance criterion or a resource criterion.

Example 57 includes the subject matter of any of Examples 51-56, and wherein the means for identifying the performance criterion comprises means for identifying at least one of a usage threshold or a quality of service requirement.

Example 58 includes the subject matter of any of Examples 51-57, and wherein the means for identifying the resource criterion comprises means for identifying at least one of a compute availability, memory availability, or storage availability.

Example 59 includes the subject matter of any of Examples 51-58, and further including means for discovering the physical resources of the cloud computing infrastructure, wherein the means for discovering the physical resources comprises means for discovering at least one of a plurality of switches of the cloud computing infrastructure, capabilities of each of the plurality of switches, a plurality of compute nodes of the cloud computing infrastructure, capabilities of each of the plurality of compute nodes, or a topology of the physical resources.

Example 60 includes the subject matter of any of Examples 51-59, and further including means for monitoring the physical resources based on the identified network criteria.

Example 61 includes the subject matter of any of Examples 51-60, and wherein the means for monitoring the physical resources comprises means for monitoring at least one of one or more physical network interfaces of one or more of the plurality of compute nodes, one or more virtual network interfaces of one or more of the plurality of compute nodes, or one or more switch ports of one or more of the plurality of switches.

Example 62 includes the subject matter of any of Examples 51-61, and wherein the means for identifying the physical resources of the cloud computing infrastructure usable to create the new tenant network is further based on a result of the monitored physical resources.

Example 63 includes the subject matter of any of Examples 51-62, and further including means for identifying present network performance metrics for the underlay network based on a result of the monitored physical resources.

Example 64 includes the subject matter of any of Examples 51-63, and further including means for receiving an indication of a virtual machine instance to be instantiated in the underlay network; means for identifying one or more present network performance metrics of the underlay network; means for updating network performance criteria associated with monitoring performance levels of the underlay network; means for comparing the one or more present network performance metrics and the updated network performance criteria; and means for determining whether the underlay network can support instantiation of the virtual machine instance.

Example 65 includes the subject matter of any of Examples 51-64, and further including means for initiating, in response to a determination that the underlay network cannot support instantiation of the virtual machine instance, creation of a new underlay network that includes the virtual machine instance to be instantiated.

Example 66 includes the subject matter of any of Examples 51-65, and further including means for identifying, in response to a determination that the underlay network can support instantiation of the virtual machine instance, a target compute node in which to instantiate the virtual machine instance; means for instantiating the virtual machine instance on the identified target compute node; and means for attaching the instantiated virtual machine instance to the cloud visible overlay network associated with the underlay network.

1. A network controller for deploying dynamic underlay networks in a cloud computing infrastructure, the network controller comprising:
one or more processors; and
one or more memory devices having stored therein a plurality of instructions that, when executed by the one or more processors, cause the network controller to:
receive, from a cloud operating system of the cloud computing infrastructure, a tenant network creation request that indicates a tenant network is to be created in the cloud computing infrastructure for a new tenant of the cloud computing infrastructure;
identify network criteria for the tenant network based on the received tenant network creation request;
identify physical resources of the cloud computing infrastructure usable to create the tenant network based on the identified network criteria;
provision an underlay network to support the tenant network based on the identified physical resources; and
transmit information of the underlay network to the cloud operating system, wherein the information of the underlay network is usable to create a cloud visible overlay network associated with the underlay network.

2. The network controller of claim 1, wherein to identify the physical resources of the cloud computing infrastructure comprises to (i) identify one or more target compute nodes for instantiation of one or more virtual machines to be associated with the tenant network and (ii) identify one or more switches coupling the one or more identified target compute nodes to the cloud computing infrastructure.

3. The network controller of claim 2, wherein to provision the underlay network comprises to (i) initialize a virtual local area network (VLAN) interface over a physical network interface of the one or more identified target compute nodes and (ii) configure switch ports of the one or more switches to configure a VLAN between the one or more switches.

4. The network controller of claim 1, wherein to receive the tenant network creation request comprises to receive an indication that one or more virtual machines are to be instantiated to support the tenant network, and
wherein the plurality of instructions further cause the network controller to:
instantiate the one or more virtual machines at one or more target compute nodes of the cloud computing infrastructure; and
attach the one or more instantiated virtual machines to the cloud visible overlay network associated with the underlay network.

5. The network controller of claim 1, wherein to identify the network criteria usable to create the tenant network comprises to identify at least one of a performance criterion or a resource criterion, wherein the performance criterion includes at least one of a usage threshold or a quality of service requirement, and wherein the resource criterion includes at least one of a compute availability, memory availability, or storage availability.

6. The network controller of claim 1, wherein the plurality of instructions further cause the network controller to discover the physical resources of the cloud computing infrastructure, wherein to discover the physical resources comprises to discover at least one of a plurality of switches of the cloud computing infrastructure, capabilities of each of the plurality of switches, a plurality of compute nodes of the cloud computing infrastructure, capabilities of each of the plurality of compute nodes, or a topology of the physical resources.

7. The network controller of claim 6, wherein the plurality of instructions further cause the network controller to monitor the physical resources based on the identified network criteria, and wherein to monitor the physical resources comprises to monitor at least one of one or more physical network interfaces of one or more of the plurality of compute nodes, one or more virtual network interfaces of one or more of the plurality of compute nodes, or one or more switch ports of one or more of the plurality of switches.

8. The network controller of claim 7, wherein to identify the physical resources of the cloud computing infrastructure usable to create the tenant network is further based on a result of the monitored physical resources, wherein the plurality of instructions further cause the network controller to identify present network performance metrics for the underlay network based on a result of the monitored physical resources.

9. The network controller of claim 1, wherein the plurality of instructions further cause the network controller to (i) receive an indication of a virtual machine instance to be instantiated in the underlay network, (ii) identify one or more present network performance metrics of the underlay network, (iii) update network performance criteria associated with monitoring performance levels of the underlay network, (iv) compare the one or more present network performance metrics and the updated network performance criteria, and (v) determine whether the underlay network can support instantiation of the virtual machine instance.

10. The network controller of claim 9, wherein the plurality of instructions further cause the network controller to initiate, in response to a determination that the underlay network cannot support instantiation of the virtual machine instance, creation of a new underlay network that includes the virtual machine instance to be instantiated.

11. The network controller of claim 9, wherein the plurality of instructions further cause the network controller to (i) identify, in response to a determination that the underlay network can support instantiation of the virtual machine instance, a target compute node in which to instantiate the virtual machine instance, (ii) instantiate the virtual machine instance on the identified target compute node, and (iii) attach the instantiated virtual machine instance to the cloud visible overlay network associated with the underlay network.

12. One or more computer-readable storage media comprising a plurality of instructions stored thereon that in response to being executed cause a network controller to:
receive, from a cloud operating system of the cloud computing infrastructure, a tenant network creation request that indicates a tenant network is to be created in the cloud computing infrastructure for a new tenant of the cloud computing infrastructure;
identify network criteria for the tenant network based on the received tenant network creation request;
identify physical resources of the cloud computing infrastructure usable to create the tenant network based on the identified network criteria;
provision an underlay network to support the tenant network based on the identified physical resources; and
transmit information of the underlay network to the cloud operating system, wherein the information of the underlay network is usable to create a cloud visible overlay network associated with the underlay network.

13. The one or more computer-readable storage media of claim 12, wherein to identify the physical resources of the cloud computing infrastructure comprises to (i) identify one or more target compute nodes for instantiation of one or more virtual machines to be associated with the tenant network and (ii) identify one or more switches coupling the one or more identified target compute nodes to the cloud computing infrastructure.

14. The one or more computer-readable storage media of claim 13, wherein to provision the underlay network comprises to (i) initialize a virtual local area network (VLAN) interface over a physical network interface of the one or more identified target compute nodes and (ii) configure switch ports of the one or more switches to configure a VLAN between the one or more switches.

15. The one or more computer-readable storage media of claim 12, wherein to receive the tenant network creation request comprises to receive an indication that one or more virtual machines are to be instantiated to support the tenant network, and
wherein the plurality of instructions further cause the network controller to:
instantiate the one or more virtual machines at one or more target compute nodes of the cloud computing infrastructure; and
attach the one or more instantiated virtual machines to the cloud visible overlay network associated with the underlay network.

16. The one or more computer-readable storage media of claim 12, wherein to identify the network criteria usable to create the tenant network comprises to identify at least one of a performance criterion or a resource criterion, wherein the performance criterion includes at least one of a usage threshold or a quality of service requirement, and wherein the resource criterion includes at least one of a compute availability, memory availability, or storage availability.

17. The one or more computer-readable storage media of claim 12, wherein the plurality of instructions further cause the network controller to discover the physical resources of the cloud computing infrastructure, wherein to discover the physical resources comprises to discover at least one of a plurality of switches of the cloud computing infrastructure, capabilities of each of the plurality of switches, a plurality of compute nodes of the cloud computing infrastructure, capabilities of each of the plurality of compute nodes, or a topology of the physical resources.

18. The one or more computer-readable storage media of claim 17, wherein the plurality of instructions further cause the network controller to monitor the physical resources based on the identified network criteria, and wherein to monitor the physical resources comprises to monitor at least one of one or more physical network interfaces of one or more of the plurality of compute nodes, one or more virtual network interfaces of one or more of the plurality of compute nodes, or one or more switch ports of one or more of the plurality of switches.

19. The one or more computer-readable storage media of claim 18, wherein to identify the physical resources of the cloud computing infrastructure usable to create the tenant network is further based on a result of the monitored physical resources, and wherein the plurality of instructions further cause the network controller to identify present network performance metrics for the underlay network based on a result of the monitored physical resources.

20. The one or more computer-readable storage media of claim 12, wherein the plurality of instructions further cause the network controller to (i) receive an indication of a virtual machine instance to be instantiated in the underlay network, (ii) identify one or more present network performance metrics of the underlay network, (iii) update network performance criteria associated with monitoring performance levels of the underlay network, (iv) compare the one or more present network performance metrics and the updated network performance criteria, and (v) determine whether the underlay network can support instantiation of the virtual machine instance.

21. The one or more computer-readable storage media of claim 20, wherein the plurality of instructions further cause the network controller to initiate, in response to a determination that the underlay network cannot support instantiation of the virtual machine instance, creation of a new underlay network that includes the virtual machine instance to be instantiated.

22. The one or more computer-readable storage media of claim 20, wherein the plurality of instructions further cause the network controller to (i) identify, in response to a determination that the underlay network can support instantiation of the virtual machine instance, a target compute node in which to instantiate the virtual machine instance, (ii) instantiate the virtual machine instance on the identified target compute node, and (iii) attach the instantiated virtual machine instance to the cloud visible overlay network associated with the underlay network.

23. A method for deploying dynamic underlay networks in a cloud computing infrastructure, the method comprising:
receiving, by a network controller in the cloud computing infrastructure, a tenant network creation request from a cloud operating system of the cloud computing infrastructure, wherein the tenant network creation request indicates to the network controller to create a new tenant network in the cloud computing infrastructure;
identifying, by the network controller, network criteria for the new tenant network based on the received tenant network creation request;
identifying, by the network controller, physical resources of the cloud computing infrastructure usable to create the new tenant network based on the identified network criteria;
provisioning, by the network controller, an underlay network to support the new tenant network based on the identified physical resources; and
transmitting, by the network controller, information of the underlay network to the cloud operating system, wherein the information of the underlay network is usable to create a cloud visible overlay network associated with the underlay network.

24. The method of claim 23, wherein to identify the physical resources of the cloud computing infrastructure comprises to (i) identify one or more target compute nodes for instantiation of one or more virtual machines to be associated with the tenant network and (ii) identify one or more switches coupling the one or more identified target compute nodes to the cloud computing infrastructure, and wherein to provision the underlay network comprises to (i) initialize a virtual local area network (VLAN) interface over a physical network interface of the one or more identified target compute nodes and (ii) configure switch ports of the one or more switches to configure a VLAN between the one or more switches.

24. The method of claim 23, wherein to receive the tenant network creation request comprises to receive an indication that one or more virtual machines are to be instantiated to support the tenant network, and
wherein the plurality of instructions further cause the network controller to:
instantiate the one or more virtual machines at one or more target compute nodes of the cloud computing infrastructure; and
attach the one or more instantiated virtual machines to the cloud visible overlay network associated with the underlay network.

25. The method of claim 23, wherein identifying the network criteria usable to create the tenant network comprises identifying at least one of a performance criterion or a resource criterion, wherein the performance criterion includes at least one of a usage threshold or a quality of service requirement, and wherein the resource criterion includes at least one of a compute availability, memory availability, or storage availability.

26. The method of claim 23, further comprising discovering, by the network controller, the physical resources of the cloud computing infrastructure, wherein discovering the physical resources comprises discovering at least one of a plurality of switches of the cloud computing infrastructure, capabilities of each of the plurality of switches, a plurality of compute nodes of the cloud computing infrastructure, capabilities of each of the plurality of compute nodes, or a topology of the physical resources.

27. The method of claim 26, further comprising monitoring, by the network controller, the physical resources based on the identified network criteria, and wherein monitoring the physical resources comprises monitoring at least one of one or more physical network interfaces of one or more of the plurality of compute nodes, one or more virtual network interfaces of one or more of the plurality of compute nodes, or one or more switch ports of one or more of the plurality of switches.

28. A network controller for deploying dynamic underlay networks in a cloud computing infrastructure, the network controller comprising:
an application interface circuit to receive a tenant network creation request from a cloud operating system of the cloud computing infrastructure, wherein the tenant network creation request indicates to the network controller to create a new tenant network in the cloud computing infrastructure;
means for identifying network criteria for the new tenant network based on the received tenant network creation request;
means for identifying physical resources of the cloud computing infrastructure usable to create the new tenant network based on the identified network criteria; and
means for provisioning an underlay network to support the new tenant network based on the identified physical resources,
means for transmitting information of the underlay network to the cloud operating system, wherein the information of the underlay network is usable to create a cloud visible overlay network associated with the underlay network.

29. The network controller of claim 28, wherein the means for identifying the physical resources of the cloud computing infrastructure comprises means for (i) identifying one or more target compute nodes for instantiation of one or more virtual machines to be associated with the new tenant network and (ii) identifying one or more switches coupling the one or more identified target compute nodes to the cloud computing infrastructure.

30. The network controller of claim 29, wherein the means for provisioning the underlay network comprises means for (i) initializing a virtual local area network (VLAN) interface over a physical network interface of the one or more identified target compute nodes and (ii) configuring switch ports of the one or more switches to configure a VLAN between the one or more switches.
